(19) United States
(12) Patent Application Publication
(10) Pub. No.: US 2006/0093958 A1
(43) Pub. Date: May 4, 2006

(54) Color forming compositions and associated methods

(76) Inventors: Vladek Kasperchik, Corvallis, OR (US); Makarand P. Gore, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/976,553

(22) Filed: Oct. 28, 2004

(51) Int. Cl. G03C 1/76

(52) U.S. Cl. 430/270.1

(57) ABSTRACT

Compositions and methods for production of color images which are developable at sub-infrared wavelengths are disclosed and described. The color forming composition can include a polymer matrix having a color former phase adjacent to or dispersed within the polymer matrix. The color former phase can include a color former and an optional melting aid. Further, a radiation absorber can be admixed with or in thermal contact with the color former phase. The color forming composition can also be optimized for development using electromagnetic radiation having a development wavelength from about 300 nm to about 500 nm. The color forming compositions are useful in forming images on a wide variety of substrates such as optical disks.

### FIELD OF THE INVENTION

The present invention relates generally to color forming compositions. More particularly, the present invention relates to methods and compositions which rapidly form color images in the indigo and blue light wavelength ranges.

### BACKGROUND OF THE INVENTION

Compositions which produce a color change upon exposure to energy in the form of light or heat are of great interest in producing images on a variety of substrates. Optical disks represent a significant percentage of the market for data storage of software as well as of photographic, video, and/or audio data. Typically, optical disks have data patterns embedded thereon that can be read from and/or written to one side of the disk, and a graphic display or label printed on the other side of the disk.

In order to identify the contents of the optical disk, printed patterns or graphic display information can be provided on the non-data, or label, side of the disk. The patterns or graphic display can be both decorative and provide pertinent information about the data content of the disk. In the past, commercial labeling has been routinely accomplished using screen-printing methods. While this method can provide a wide variety of label content, it tends to be cost ineffective for production of less than about 400 customized disks because of the fixed costs associated with preparing a stencil or combination of stencils and printing the desired pattern or graphic display.

In recent years, the significant increase in the use of optical disks for data storage by consumers has increased the demand to provide customized labels to reflect the content of the optical disk. Most consumer available methods of labeling are limited to either handwritten descriptions which lack professional appearance, quality and variety, or preprinted labels which may be affixed to the disk, but which can also adversely affect the disk performance upon spinning at high speeds.

Recently, color forming compositions have been developed which can be developed using energy sources such as lasers in order to form an image. However, these color forming compositions are often useful for only very specific applications and have a limited color palette. For this and other reasons, the need still exists for color forming compositions which increase the available options for such imaging systems.

### SUMMARY OF THE INVENTION

It has been recognized that it would be advantageous to provide rapidly developable color forming compositions which are developable at sub-infrared wavelengths. In one aspect of the present invention, a color forming composition can include a polymer matrix having a color former phase adjacent to or dispersed within the polymer matrix. The color former phase can include a color former and an optional melting aid. Further, a radiation absorber can be admixed with or in thermal contact with the color former phase. The color forming composition can also be optimized for development using electromagnetic radiation having a development wavelength from about 300 nm to about 500 nm.

A system for developing such color forming compositions can include a substrate having the color forming composition thereon. As part of this system, an image data source can be used to selectively direct electromagnetic radiation from an electromagnetic radiation source. The color forming composition and electromagnetic radiation source can be configured to sufficiently heat the color forming composition to develop the color former.

Additional aspects and advantages of the invention will be apparent from the detailed description which follows.

### DETAILED DESCRIPTION OF THE PREFERRED EMBODIMENT(S)

Reference will now be made to exemplary embodiments and specific language will be used herein to describe the same. It will nevertheless be understood that no limitation of the scope of the invention is thereby intended. Alterations and further modifications of the inventive features described herein and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a radiation absorber” includes reference to one or more of such materials.

As used herein, the term “color forming composition” typically includes a color former, a radiation absorber, and a polymer matrix. These components can work together upon exposure to radiation to develop the color former to produce a dye having color or a change in color. For purposes of the present invention, the term “color” or “colored” can refer to change in visible absorbance that occurs upon development, including development to black, white, or traditional colors. An undeveloped color former can be colorless or may have some color which changes upon development to a different color.

As used herein, the term “color former” refers to any composition which changes color upon application of energy. Color formers can typically include leuco dyes, photochromic dyes, or the like.

As used herein, “developing,” “development,” or the like refers to an interaction or reaction which affects the leuco dye to produce a visible change in color through reduction to the corresponding colored leuco dye. Most often, the leuco dye is reduced to form a color.

As used herein, “radiation absorber” refers generally to a radiation sensitive agent that can generate heat or otherwise transfer energy to surrounding molecules upon exposure to radiation at a specific wavelength. When admixed with or in thermal contact with a leuco dye and/or a corresponding activator, a radiation absorber can be present in sufficient quantity so as to produce energy sufficient to at least partially develop the leuco dye.

As used herein, “thermal contact” refers to the spatial relationship between an absorber and a color forming composition. For example, when an absorber is heated by interaction with laser radiation, the energy generated by the absorber should be sufficient to cause the leuco dye of the color forming composition to darken, change, or become colored, through a chemical reaction. Thermal contact can include close proximity between an absorber and a color forming composition, which allows for energy transfer from the absorber toward the leuco dye and/or activator. Thermal contact can also include actual contact between an absorber and color former, such as in immediately adjacent layers, or in an admixture including both constituents.

As used herein, the term “spin-coatable composition” includes a liquid carrier having various components dissolved or dispersed therein. In some embodiments, the spin-coatable composition can comprise a leuco dye, uncured polymer matrix material, and a radiation absorber in a common liquid carrier. In other embodiments, fewer components can be present in a liquid carrier forming the spin-coatable composition. Color forming compositions can be spin-coatable in one embodiment, or can be configured for other application methods as well, e.g., printing such as offset, ink-jet, gravure, roller coating, screen printing, spraying, or other application methods known to those skilled in the art.

As used herein, “optimization” and “optimized” refer to a process of selection of components of the color forming composition which results in a rapidly developable composition under a fixed period of exposure to radiation at a specified power. For example, compositions of the present invention can be optimized for development using 405 nm laser light in which the color forming composition exposed to the radiation is developed in less than a predetermined period of time, e.g., 5 ms to 100 μsec. However, “optimized” does not necessarily indicate that the color forming composition is developed most rapidly at a specific wavelength, but rather that the composition can be developed within a specified time frame using a given radiation source. An optimized composition would also indicate an ambient light stability over extended periods of time, i.e. several months to years. Thus, an optimized composition results from a combination of all components of the color forming composition in affecting development characteristics and stability.

As used herein, “optical disk” is meant to encompass audio, video, multi-media, and/or software disks that are machine readable in a CD and/or DVD drive, or the like. Examples of optical disk formats include writeable, recordable, and rewriteable disks such as DVD, DVD-R, DVD-RW, DVD+R, DVD+RW, DVD-RAM, CD, CD-ROM, CD-R, CD-RW, and the like. Other like formats may also be included, such as similar formats and formats to be developed in the future.

As used herein, “graphic display” can include any visible character or image found on an optical disk. Typically, the graphic display is found prominently on one side of the optical disk, though this is not always the case.

As used herein, “data” is typically used with respect to the present disclosure to include the non-graphic information contained on the optical disk that is digitally or otherwise embedded therein. Data can include audio information, video information, photographic information, software information, and the like.

It is important to note that, with respect to color formers, radiation absorbers, stabilizers, anti-fade agents, activators, reducing agents, and other non-liquid carrier components, the weight percent values are measured relative to a dry basis, thus excluding the liquid carrier. In other words, unless otherwise specified, values of “wt %” refer to the compositions that will be present in the color forming composition excluding any carrier, such as after drying or curing, as in case of UV (ultraviolet) or EB (electron beam) curable formulations, on a substrate.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 μm to about 200 μm should be interpreted to include not only the explicitly recited limits of 1 μm to about 200 μm, but also to include individual sizes such as 2 μm, 3 μm, 4 μm, and sub-ranges such as 10 μm to 50 μm, 20 μm to 100 μm, etc.

In accordance with the present invention, a color forming composition can include a polymer matrix having a color former phase adjacent to or dispersed within the polymer matrix. The color former phase can include a color former and an optional melting aid. Further, a radiation absorber can be admixed with or in thermal contact with the color former phase. The color forming composition can also be optimized for development using electromagnetic radiation having a development wavelength from about 300 nm to about 500 nm.

Upon application of suitable electromagnetic radiation, the radiation absorber and color former are heated sufficiently to develop the color former. Specific color formers, radiation absorbers, and other components of the color forming composition can each affect the development properties and long-term stability of the color forming composition and are discussed in more detail below.

Color Former Phase

Color forming compositions of the present invention can include a color former phase dispersed within or adjacent to the polymer matrix. Typically, the color former phase is substantially insoluble in the polymer matrix and exists distinct from the polymer matrix. In one aspect of the present invention, the color former phase can be dispersed within the polymer matrix. This can be accomplished by any known method such as mixing, rolling, or the like. In most cases, it can be desirable to uniformly disperse the color former phase throughout the polymer matrix. Dispersing the color former phase within the polymer matrix allows for increased contact of the leuco dye with activator material and/or other energy transfer materials, which are discussed below in more detail. Further, a dispersion of color former phase within the polymer matrix can be formed as a single composition, e.g., a paste, which can then be coated on a substrate in a single step. The volume of color former phase dispersed within the polymer matrix can vary considerably depending on the concentration and type of color former used, as well as a number of other factors such as desired development speed, desired color intensity of developed color former, and the like. However, as a general guideline, the color former phase volume percent in the polymer matrix can be from about 1% to about 50%, and in some cases from about 10% to about 30%. Alternatively, the color former phase and polymer matrix can be formed in adjacent separate layers.

A wide variety of leuco dyes can be included within the color former phase. Almost any known color forming dye can be used, as long as the color development criteria discussed herein are met. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(phydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(phydroxyphenyl)-4,5-diphenylimidazoles, phenethylanilines, phthalocyanine precursors (such as those available from Sitaram Chemicals, India), and mixtures thereof. In one aspect of the present invention, the leuco dye can be a fluoran, phthalide, aminotriarylmethane, or mixture thereof. Additionally, fluoran based leuco dyes have proven exceptionally useful for incorporation into the color forming compositions of the present invention. Several non-limiting examples of suitable fluoran based leuco dyes include 3-diethylamino-6-methyl-7-anilinofluorane, 3-(N-ethyl-ptoluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino) fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(ochloroanilino) fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], 2-anilino-3-methyl-6-(N-ethyl-N-isoamylamino)fluorane (S-205 available from Nagase Co., Ltd), and mixtures thereof. Aminotriarylmethane leuco dyes can also be used in the present invention such as tris(N,N-dimethylaminophenyl) methane (LCV); deutero-tris(N,N-dimethylaminophenyl) methane (D-LCV); tris(N,N-diethylaminophenyl) methane(LECV); deutero-tris(4-diethylaminolphenyl) methane (D-LECV); tris(N,N-di-n-propylaminophenyl) methane (LPCV); tris(N,N-din-butylaminophenyl) methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2); tris(4-diethylamino-2-methylphenyl) methane (LV-3); bis(4-diethylamino-2-methylphenyl)(3,4-dimethoxyphenyl) methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl. Other color formers can also be used in connection with the present invention and are known to those skilled in the art. A more detailed discussion of some of these types of leuco dyes can be found in U.S. Pat. Nos. 3,658,543 and 6,251,571, each of which are hereby incorporated by reference in their entireties. Examples are found in Chemistry and Applications of Leuco Dyes, Muthyala, Ramaiha, ed.; Plenum Press, New York, London; ISBN: 0-306-45459-9, incorporated herein by reference.

Typically, the leuco dye can be present in color forming compositions of the present invention at from about 1 wt % to about 40 wt %. Although amounts outside this range can be successfully used, depending on the other components of the composition, amounts from about 5 wt % to about 20 wt % frequently provide adequate results.

In order to reduce development times and increase sensitivity to an applied radiation source, the color former phase can further include a melting aid. Suitable melting aids can have a melting temperature from about 50° C. to about 150° C. and often from about 70° C. to about 120° C. Melting aids are typically crystalline organic solids which can be melted and mixed with a particular color former. For example, most color formers are also available as a solid particulate which is soluble in standard liquid solvents. Thus, the color former and melting aid can be mixed and heated to form a molten mixture. Upon cooling, a color former phase of color former and melting aid is formed which can then be ground into a powder. In some embodiments of the present invention, the percent of color former and melting aid can be adjusted to minimize the melting temperature of the color former phase without interfering with the development properties of the leuco dye. When used, the melting aid can comprise from about 5 wt % to about 25 wt % of the color former phase.

A number of melting aids can be effectively used in the color forming compositions of the present invention. Several non-limiting examples of suitable melting aids include m-terphenyl, p-benzyl biphenyl, alpha-napthyl benzylether, disk recording equipment provide for energy at a wavelength of about 405 nm. Thus, the compositions of the present invention using appropriate radiation absorbers can be suited for use with components that are already available on the market or are readily modified to accomplish imaging. In one embodiment, wavelengths from about 300 nm to about 500 nm can be used in accordance with the present invention, and in one aspect, can be from about 390 nm to about 420 nm. In another more specific aspect, the radiation can have a wavelength of about 405 nm.

The radiation absorber can be configured to be in a heat-conductive relationship with the leuco dyes of the present invention. For example, the radiation absorber can be included within the color former phase, the polymer matrix, and/or a separate layer. Thus, the radiation absorber can be admixed with or in thermal contact with the leuco dye. Typically, the radiation absorber can be present in both the color former phase and the polymer matrix. In this way, substantially the entire color forming composition in an exposed area can be heated quickly and substantially simultaneously. This is also beneficial when an activator is included in the polymer matrix. Alternatively, the radiation absorber can be applied as a separate layer which can be optionally spin-coatable or screen-printable.

Consideration can also be given to choosing the radiation absorber such that any light absorbed in the visible range does not adversely affect the graphic display or appearance of the color forming composition either before or after development.

A radiation absorber suitable for the present invention can have a maximum light absorption at or in the vicinity of the desired radiation wavelength, e.g., 300 nm to 500 nm. Typical examples of suitable radiation absorbers can include, but are not limited to, 1-(2-chloro-5-sulfophenyl)-3-methyl-4-(4-sulfophenyl)azo-2-pyrazolin-5-one disodium salt (λmax=400 nm); ethyl 7-diethylaminocoumarin-3-carboxylate (λmax=418 nm); 3,3′-diethylthiacyanine ethylsulfate (λmax=424 nm); 3-allyl-5-(3-ethyl-4-methyl-2-thiazolinylidene) rhodanine (λmax=430 nm) (each available from Organica Feinchemie GmbH Wolfen), and mixtures thereof. Additionally, radiation absorbers such as aluminum quinoline complexes, porphyrins, porphins, and mixtures or derivatives thereof can also be suitable. Non-limiting specific examples of suitable quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH. Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Merthyl Yellow (60-11-7), 4-phenylazoaniline (CAS 60-09-3), Alcian Yellow (CAS 61968-76-1), available from Aldrich chemical company, and mixtures thereof. In formulating the color forming composition of the present invention, an optimized composition can depend on a variety of factors, since each component can affect the development properties, e.g., time, color intensity, etc. For example, a color forming composition having a radiation absorber with a maximum absorption of about 430 nm may not develop most rapidly at 430 nm. Other components and the specific formulation can result in an optimized composition at a wavelength which does not correspond to the maximum absorption of the radiation absorber. Thus, the process of formulating an optimized color forming composition includes testing formulations to achieve a desired development time using a specific intensity and wavelength of energy to form an acceptable color change.

A majority of the suitable radiation absorbers with light absorbing characteristics in the vicinity of 405 nm have a yellow or yellowish coloration. Therefore, color forming compositions containing such radiation absorbers tend to have yellow coloration or slightly yellowish tint. In order to achieve a visible contrast between developed areas and non-imaged or non-developed areas of the coating, the color former can be chosen to form a color that is different than that of the background. For example, color formers having a developed color such as black, blue, red, magenta, and the like can provide a good contrast to a more yellow background. Optionally, an additional non-leuco colorant can be added to the color forming compositions of the present invention or the substrate on which the color forming composition is placed. Any known non-leuco colorant can be used to achieve almost any desired background color for a given commercial product. Although the specific color formers and absorbers discussed herein are typically separate compounds, such activity can also be provided by constituent groups of a binder and/or color former which is incorporated in the activation and/or radiation absorbing action within the color former and is considered within the scope of the present invention. Generally, the radiation absorber can be present in the color forming composition in an amount of from about 0.001 wt % to about 10 wt %, and typically, from about 0.5 wt % to about 1 wt %, although other weight ranges may be desirable depending on the activity of the particular absorber.

Polymer Matrix

The color forming compositions of the present invention can typically include a polymer matrix which acts primarily as a binder. As mentioned above, the color former phase can be dispersed within the polymer matrix. Various polymer matrix materials can influence the development properties of the color forming composition such as development speed, light stability, and wavelengths which can be used to develop the composition. Acceptable polymer matrix materials can also include, by way of example, UV curable polymers such as acrylate derivatives, oligomers, and monomers, such as included as part of a photo package. A photo package can include a light absorbing species which initiates reactions for curing of a lacquer. Such light absorbing species can be sensitized for curing using UV or electron beam curing systems, such as, by way of example, benzophenone derivatives. Other examples of photoinitiators for free radical polymerization monomers and pre-polymers can include, but are not limited to, thioxanethone derivatives, anthraquinone derivatives, acetophenones, and benzoine ethers.

In particular embodiments of the invention, it can be desirable to choose a polymer matrix which is cured by a form of radiation that does not also develop the color former or otherwise decrease the stability of the color forming composition at the energy input and flux necessary to cure the coatings. Thus, the polymer matrix can be curable at a curing wavelength which is substantially different than the development wavelength.

Further, a suitable photoinitiator should also have light absorption band which is not obscured by the absorption band of the radiation absorber, otherwise the radiation absorber can interfere with photoinitiator activation and thus prevent cure of the coating. Therefore, in one practical embodiment, a photoinitiator light absorption band can lie within the UV region, e.g., from about 200 to about 380 nm, and the absorber band lies from about 390 to about 420 nm. However, in practice these band overlap. A working system design is possible because the energy flux required for development of a color former is about ten times higher than needed for initiation of the cure. In yet another embodiment, the absorber has a dual function; one of sensitization of cure for UV cure under cure conditions (relatively low energy flux), and provides for energy for marking during the marking fraction. This is possible because the energy flux during cure is typically an order of magnitude lower than needed for producing a mark. Polymer matrix materials based on cationic polymerization resins can include photo-initiators based on aromatic diazonium salts, aromatic halonium salts, aromatic sulfonium salts, and metallocene compounds. Additional examples of curing agents are α-aminoketones, α-hydroxyketones, phosphineoxides available from Ciba-Geigy under the name of Irgacure and Darocure agents, and sensitizers such as 2-isopropyl-thioxanthone. One specific example of a suitable polymer matrix is Nor-Cote CDG-1000 (a mixture of UV curable acrylate monomers and oligomers) which contains a photoinitiator (hydroxy ketone) and organic solvent acrylates (e.g., methyl methacrylate, hexyl methacrylate, beta-phenoxy ethyl acrylate, and hexamethylene acrylate), available form Nor-Cote. Other suitable components for polymer matrix materials can include, but are not limited to, acrylated polyester oligomers, such as CN293 and CN294 as well as CN-292 (low viscosity polyester acrylate oligomer), SR-351 (trimethylolpropane triacrylate), SR-395(isodecyl acrylate) and SR-256(2(2-ethoxyethoxy) ethyl acrylate), all of which are available from Sartomer Co.

Additionally, binders can be included as part of the polymer matrix. Suitable binders can include, but are not limited to, polymeric materials such as polyacrylate from monomers and oligomers, polyvinyl alcohols, polyvinyl pyrrolidines, polyethylenes, polyphenols or polyphenolic esters, polyurethanes, acrylic polymers, and mixtures thereof. For example, the following binders can be used in the color forming composition of the present invention: cellulose acetate butyrate, ethyl acetate butyrate, polymethyl methacrylate, polyvinyl butyral, and mixtures thereof.

Other Optional Ingredients

The color forming compositions of the present invention can also include various additional components such as colorants, liquid vehicles, stabilizers, anti-fade agents, plasticizers, and other additives known to those skilled in the art.

Depending on the specific leuco dye, the color forming composition can optionally include a reducing agent. Typical reducing agents include 1-phenyl-3-pyrozolidone (phenidone), hydrazine, formamide, formic acid, hexaarylbiimidazoles (HABI), ascorbic acid, phenols and substituted phenols, e.g., hydroquinone, and mixtures thereof.

In certain embodiments of the present invention, it is sometimes desirable to add a plasticizer to improve coating flexibility, durability, and coating performance. Plasticizers can be either solid or liquid plasticizers. Such suitable plasticizers are well known to those skilled in the art, as exemplified in U.S. Pat. No. 3,658,543, which is incorporated herein by reference in its entirety. Specific examples of plasticizers include, but are not limited to, cellulose esters such as an o-phenyl phenol ethylene oxide adduct (commercially available as MERPOL 2660 from E. I. Du Pont de Nemours & Co., Wilmington, Del.), polyethylene glycols and substituted phenolethylene oxide adducts such as nonylphenoxypoly(ethyleiieoxy)-ethanol (commercially available as IGEPAL CO 210 from Aldrich Chemical Co.), acetates, butyrates, cellulose acetate butyrates, and mixtures thereof. The plasticizer can be included in either or both of the polymer matrix and the color former phase.

Other additives can also be utilized for producing particular commercial products such as including a colorant to impart additional desired color to the image. The colorants can be color formers which are developed at wavelengths outside the range of 300 nm to 500 nm or non-leuco colorants which can provide a background color. In one embodiment, optional colorants can be standard pigments and/or dyes. For example, the use of an opacifier pigment or other colorant can provide background color to the substrate. The optional colorants can be added to the color forming composition, underprinted, or overprinted, as long as the development of the color former is not prevented from at least some development due to the presence of the optional colorant.

In one embodiment, the color forming composition can be prepared in a solution which is substantially transparent or translucent. Any suitable liquid carrier, e.g., an alcohol with a surfactant, can be used which is compatible with a particular color former, polymer matrix, and/or other components chosen for use. The liquid carrier can include, but is not limited to, solvents such as methylethyl ketone, isopropyl alcohol or other alcohols and diols, water, surfactants, and mixtures thereof. When the color forming composition is prepared in a solution form, it may be desirable to underprint a colored coating over at least a portion of the substrate beneath the color forming composition. The optional colored coating produces a background color that can be visible underneath the solution layer. This colored coating can contain various colorants such as other pigments and/or dyes.

The color forming composition can be prepared in a number of ways for application to a substrate. Often, the liquid carrier can be used which can be at least partially removed through known solvent removal processes. Typically, at least a portion of the liquid carrier can be driven off or allowed to evaporate after the coating process is complete. Further, various additional components, such as lubricants, surfactants, and materials imparting moisture resistance, can also be added to provide mechanical protection to the color forming composition. Other overcoat compositions can also be used and are well known to those skilled in the art.

In one aspect of the present invention, the color forming composition can be spin-coatable. In order to provide desirable color forming properties and spin-coatability, various factors such as viscosity and solids content can also be considered. The color forming compositions of the present invention can have less than about 10 wt % of solids, which typically provides good coating properties. For example, in one aspect, the solids content of a spin-coatable color forming composition can be from about 5 wt % to about 9 wt %.

Typically, particular leuco dyes can require an activator to facilitate reduction to the colored form of the leuco dye. In one embodiment, the activator can be present in the polymer matrix. Typically, the activator can be readily dissolved in the polymer matrix. In some embodiments, the activator can be an acidic phenolic compound. Non-limiting examples of suitable activators include bis-phenol A, p-hydroxy benzyl benzoate, TG-SA (Phenol, 4,4-α-sulfonylbis[2-(2-propenyl)), and poly-phenols. Examples of additional acidic materials that can be use as activators include any lewis acid, without limitation, phenols, carboxylic acids, cyclic sulfonamides, protonic acids, zinc chloride, magnesium carboxylates, zinc carboxylates, calcium carboxylates, transistion metal salts and other compounds having a pKa of less than about 7.0, and mixtures thereof. Specific phenolic and carboxylic secondary activators can include, without limitation, boric acid, oxalic acid, maleic acid, tartaric acid, citric acid, succinic acid, benzoic acid, stearic acid, gallic acid, salicylic acid, 1-hydroxy-2-naphthoic acid, o-hydroxybenzoic acid, m-hydroxybenzoic acid, 2-hydroxy-p-toluic acid, 3,5-xylenol, thymol, p-t-butylphenyl, 4-hydroxyphenoxide, methyl-4-hydroxybenzoate, 4-hydroxyacetophenone, α-naphthol, naphthols, catechol, resorcin, hydroquinone, 4-t-octylcatechol, 4,4′-butylidenephenol, 2,2′-dihydroxydiphenyl, 2,2′-methylenebis(4-methyl-6-t-butyl-phenol), 2,2′-bis(4′-hydroxyphenyl) propane, 4,4′-isopropylidenebis(2-t-butylphenol), 4,4′-secbutylidenediphenol, pyrogallol, phloroglucine, phlorogluocinocarboxylic acid, 4-phenylphenol, 2,2′-methylenebis(4-chlorophenyl), 4,4′-isopropylidenediphenol, 4,4′-isopropylidenebis(2-chlorophenol), 4,4′-isopropylidenebis(2-methylphenol), 4,4′-ethylenebis(2-methylphenol), 4,4′-thiobis(6-t-butyl-3methylphenol), bisphenol A and its derivatives (such as 4,4′-isopropylidenediphenol, 4-4′-cyclohexylidenediphenol, p,p′-(1-methyl-n-hexylidene) diphenol, 1,7-di (4-hydroxyphenylthio)-3,5-dioxaheptane), 4-hydroxybenzoic esters, 4-hydroxyphthalic diesters, phthalic monoesters, bis(hydroxyphenyl)sulfides, 4-hydroxyarylsulfones, 4hydroxyphenylarylsulfonates, 1,3-di[2(hydroxyphenyl)-2-propyl]benzenes, 1,3-dihydroxy-6(α,α-dimethylbenzyl)benzene, resorcinols, hydroxybenzoyloxybenzoic esters, bisphenolsulfones, bis-(3-allyl-4-hydroxyphenyl)sulfone (TG-SA), bisphenolsulfonic acids, 2,4dihydroxy-benzophenones, novolac type phenolic resins, polyphenols, saccharin, 4-hydroxy-acetophenone, p-phenylphenol, benzyl-p-hydroxybenzoate (benzalparaben), 2,2-bis(p-hydroxyphenyl) propane, p-tert-butylphenol, 2,4-dihydroxy-benzophenone, and p-benzylphenol.

Radiation Application for Development

In one embodiment of the present invention, the color forming composition can be applied to a substrate. The composition can be applied to the substrate using any known technique such as spin-coating, screen printing, sputtering, spray coating, ink-jetting, or the like. A variety of substrates can be used such as an optical disk, polymeric surface, glass, ceramic, metal, or paper. In one embodiment, the color forming composition can be applied to an optical disk and select portions thereof developed using a laser or other radiation source.

Once the color forming composition is applied to the substrate, the conditions under which the color forming compositions of the present invention are developed can be varied. For example, one can vary the electromagnetic radiation wavelength, heat flux, and exposure time. The amount of energy which is to be applied depends partially on the activation energy of the development reaction of the color former and the specific radiation absorber chosen. However, the energy applied is typically sufficient to develop the color former without also decomposing the color forming composition or damaging the substrate. Such an energy level is typically well below the energy required for decomposition of the color forming composition. Variables such as spot size, focus, and laser power will also affect any particular system design and can be chosen based on the desired results. With these variables fixed at predetermined values, the radiation source can then direct electromagnetic radiation to the color forming composition in accordance with data received from a signal processor. Further, color former and/or radiation absorber concentration and proximity to one another can also be varied to affect the development times and the optical density of the developed image.

Typically, an image to be formed on the surface can be digitally stored and then rasterized or spiralized. The resulting data can be delivered to a radiation source which exposes portions of the color forming composition to radiation while the optical disk is spinning. Any number of electromagnetic radiation sources can be used. Lasers provide a simple and effective way of delivering focused and highly controlled pulsed light at a desired wavelength such as from about 300 nm to about 500 nm. In another embodiment, the radiation source can provide a development wavelength from about 390 nm to about 420 nm. In one specific embodiment, the radiation source can be a 405 nm laser such as those found in commercially available DVD and video disk writeable and/or rewriteable systems such as BlueRay products by Sony, Matsushita (Panasonic), HP, DELL, Toshiba, Phillips NEC Corporation, and the like.

The color forming compositions of the present invention can be developed using lasers having from about 15 to 100 mW power usage, although lasers having a power outside this range can also be used. Typically, lasers having from about 30 mW to about 50 mW are readily commercially available and work well using the color forming composition described herein. The spot size generated by the laser can be determined by radiation that contacts the substrate at a single point in time. The spot size can be circular, oblong, or other geometric shape, and can range from about 1 μm to about 200 μm along a largest dimension and often from about 10 μm to about 60 μm, though smaller or larger sizes can also be used. In a further aspect, spot sizes of 20 μm by 50 μm, as measured across perpendicular major and minor axes, can provide a good balance between resolution and developing speed.

Heat flux is a variable that can be altered as well, and can be from about 0.05 to 5.0 J/cm² in one embodiment, and from about 0.3 to 0.5 J/cm² in a second embodiment. In general, a heat flux of less than 0.5 J/cm² can also be used. The color forming compositions of the present invention can be optimized by adjusting the concentrations and type of radiation absorber, color former, and polymer matrix. Heat flux in these ranges allow for development of color formers in optimized compositions in from about 10 μsec to about 100 μsec per dot in some embodiments. Further, the color forming compositions of the present invention can be optimized for development in less than about 1 millisecond, and in some embodiments less than about 500 μsec. In some embodiments, the color forming compositions of the present invention can be optimized for development in from about 100 μsec to about 500 μsec. Those skilled in the art can adjust these and other variables to achieve a variety of resolutions and developing times. In embodiments where the substrate is an optical disk or other moving substrate, the exposure time will depend on the rate of motion of the substrate. More specifically, in such embodiments, the exposure times above refer the time during which a point on the substrate is exposed to the radiation. For example, a spot size of 50 μm along the direction of rotation will result in a single point on the substrate traveling through the spot starting at one edge and traveling to the opposite edge. The total exposure time is therefore the average time that radiation contacts a particular point on the substrate or color forming composition.

The following example illustrates exemplary embodiments of the invention. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what is presently deemed to be practical embodiments of the invention.

### EXAMPLE

A material for use as the color former phase was prepared by melting 0.45 gm of m-Terphenyl in a heated crucible. Subsequently, 4.5 gm of Color former BK-400 was added into the molten melting aid. The mixture was heated to 180° C. and mixed until the color former was completely dissolved. Finally, 0.09 gm of the absorber dye chosen from ST-1041, ST-1131, or ST-38, available from Syntec, Wolfen, Germany, was added and thoroughly mixed to cause a solution. The molten mixture was then quickly cooled down and ground into fine powder having an average particle size of 2 to 7 μm.

The polymer matrix was prepared by mixing 0.18 gm of finely ground Bisphenol S (4,4′-sulfonylbis-phenol), 0.41 gm of developer D-8, and 0.11 gm of developer YSR (all available from Sophix corporation, KY) and 0.085 gm of 1:1 m-terphenyl alloy of absorber dye chosen from ST-1041, ST-1131, or ST-38, available from Syntec, Wolfen, Germany, in 2.33 gm of CLCDG-1250A UV-curable lacquer (available from Nor-Cote International) and allowed the mixture to stand overnight. Subsequently, 0.54 gm Irgacure 1300 photo-initiator was added into the polymer matrix mixture. Finally, 1.58 g of the color former phase powder was combined with the resulting polymer matrix mixture into a UV-curable thermochromic paste. The paste was run three times through a three roll mill in order to ensure adequate mixing uniformity. The resulting paste was screen printed onto a substrate at a thickness of about 5 μm to about 7 μm to form a color forming composition on a substrate. The polymer matrix on the medium was then UV cured by mercury lamp. Upon curing the polymer matrix, the coating was directly marked by a 20 mW 405 nm laser. A clear mark of approximately 7 μm×45 μm was produced in less than 5 ms. Direct marking occurs when the desired image is marked on the imaging medium, without the use of a printing intermediary or ink.

It is to be understood that the above-referenced arrangements are illustrative of the application for the principles of the present invention. Numerous modifications and alternative arrangements can be devised without departing from the spirit and scope of the present invention while the present invention has been described above in connection with the exemplary embodiments(s) of the invention. It will be apparent to those of ordinary skill in the art that numerous modifications can be made without departing from the principles and concepts of the invention as set forth in the claims.

What is claimed is:

1. A color forming composition, comprising:
a) a polymer matrix;
b) a color former phase adjacent to or dispersed within the polymer matrix, said color former phase including a color former; and
c) a radiation absorber admixed with or in thermal contact with the color former phase,
said color forming composition being optimized for development using electromagnetic radiation having a development wavelength from about 300 nm to about 500 nm.

2. The composition of claim 1, wherein the development wavelength is from about 390 nm to about 420 nm.

3. The composition of claim 2, wherein the development wavelength is about 405 nm.

4. The composition of claim 1, wherein the color former phase is dispersed within the polymer matrix.

5. The composition of claim 4, wherein the color former phase comprises from about 0.5% to about 50% by volume of the polymer matrix.

6. The composition of claim 4, wherein the radiation absorber is present in both the color former phase and the polymer matrix.

7. The composition of claim 1, wherein the color former phase is distinct and substantially insoluble in the polymer matrix.

8. The composition of claim 1, wherein the color former phase further comprises a melting aid.

9. The composition of claim 8, wherein the melting aid has a melting temperature from about 50° C. to about 150° C.

10. The composition of claim 8, wherein the melting aid is a member selected from the group consisting of m-terphenyl, p-benzyl biphenyl, alpha-napthyl benzylether, 1,2-bis(3,4)dimethylphenyl ethane, aromatic hydrocarbons, phenolic ethers, aromatic acid-esters, fatty acid esters, polyethylene wax, and mixtures thereof.

11. The composition of claim 1, wherein the color former is a leuco dye.

12. The composition of claim 11, wherein the leuco dye is a member selected from the group consisting of fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)-4,5-diphenylimidazoles, phenethylanilines, and mixtures thereof.

13. The composition of claim 1, wherein the radiation absorber is selected from the group consisting of 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene) rhodanine, and mixtures thereof.

14. The composition of claim 13, wherein the radiation absorber is selected from the group consisting of aluminum quinoline complexes, porphyrins, porphins, and mixtures or derivatives thereof.

15. The composition of claim 1, wherein the color forming composition is optimized for development using radiation at less than about 0.5 J/cm².

16. The composition of claim 1, wherein the color forming composition is optimized for development in less than about 1 millisecond.

17. The composition of claim 1, wherein the polymer matrix includes a UV curable polymer.

18. The composition of claim 17, wherein the UV curable polymer is curable at a curing wavelength which is substantially different than the development wavelength.

19. The composition of claim 1, wherein the polymer matrix further includes an activator.

20. The composition of claim 1, wherein the color forming composition is spin-coatable.

21. A system for labeling a substrate, comprising:
a) an image data source;
b) a substrate having a color forming composition coated thereon,
said color forming composition comprising:
i) a polymer matrix;
ii) a color former phase adjacent to or dispersed within the polymer matrix, said color former phase including a color former; and
iii) a radiation absorber admixed with or in thermal contact with the color former phase,
said color forming composition being optimized for development using electromagnetic radiation having a development wavelength from about 300 nm to about 500 nm; and
c) an electromagnetic radiation source operatively connected to the image data source and configured to direct electromagnetic radiation having a frequency from about 300 nm to about 500 nm to the color forming composition.

22. The system of claim 21, wherein the development wavelength is from about 390 nm to about 420 nm.

23. The system of claim 21, wherein the electromagnetic radiation source is a laser.

24. The system of claim 23, wherein the laser is configured to apply electromagnetic radiation at from about 0.3 J/cm² to about 0.5 J/cm².

25. The system of claim 21, wherein the color former phase is dispersed within the polymer matrix.

26. The system of claim 21, wherein the color former phase is distinct and substantially insoluble in the polymer matrix.

27. The system of claim 21, wherein the radiation absorber is a member selected from the group consisting of 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene) rhodanine, aluminum quinoline complexes, porphyrins, porphins, and mixtures or derivatives thereof.

28. The system of claim 21, wherein the color former phase further comprises a melting aid.

29. The system of claim 28, wherein the melting aid has a melting temperature from about 50° C. to about 150° C.

30. The system of claim 21, wherein the polymer matrix is a UV curable polymer.

31. The system of claim 21, wherein the substrate is an optical disk.

32. A method of forming color images on a substrate, comprising:
a) applying a color forming composition onto a substrate, said color forming composition including:
i) a polymer matrix;
ii) a color former phase adjacent to or dispersed within the polymer matrix, said color former phase including a color former; and
iii) a radiation absorber admixed with or in thermal contact with the color former,
said color forming composition being optimized for development using electromagnetic radiation having a development wavelength from about 300 nm to about 500 nm; and
b) applying electromagnetic radiation to the color forming composition sufficient to develop the color former without decomposing the color forming composition, said electromagnetic radiation having a wavelength of from about 300 nm to about 500 nm.

33. The method of claim 32, wherein the development wavelength is from about 390 nm to about 420 nm.

34. The method of claim 32, wherein the electromagnetic radiation source is a laser.

35. The method of claim 32, wherein the radiation absorber is a member selected from the group consisting of 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene) rhodanine, aluminum quinoline complexes, porphyrins, porphins, and mixtures or derivatives thereof.

36. The method of claim 32, wherein the color former phase further comprises a melting aid.

37. The method of claim 36, wherein the melting aid has a melting temperature from about 50° C. to about 150° C.

38. The method of claim 32, wherein the polymer matrix is a UV curable polymer.

39. The method of claim 32, wherein the color forming composition is optimized for development using electromagnetic radiation applied at from about 0.3 J/cm² to about 0.5 J/cm².

40. The method of claim 32, wherein the color forming composition is optimized for development using electromagnetic radiation applied for about 100 μsec to about 500 μsec.

41. The method of claim 32, wherein the electromagnetic radiation is applied using a laser having a wavelength of about 405 nm.

42. The method of claim 32, wherein the electromagnetic radiation has a spot size from about 10 μm to about 60 μm.

43. The method of claim 32, wherein the electromagnetic radiation is at a power level from about 30 mW and about 50 mW.

44. The method of claim 32, wherein the substrate is an optical disk.

45. The method of claim 44, wherein the color forming composition is applied to the optical disk by spin-coating.
